(19) United States
(12) Patent Application Publication
(10) Pub. No.: US 2014/0019293 A1
(43) Pub. Date: Jan. 16, 2014

(54) Automated Technique For Generating Recommendations Of Potential Supplier Candidates

(71) Applicants: Katy U. Brownley, Hudson, OH (US); John S. Dischinger, Danbury, CT (US); Chester Karwatowski, West Shokan, NY (US); Michael J. Martine, Chapel Hill, NC (US); Ajay Raina, Elmsford, NY (US)

(72) Inventors: Katy U. Brownley, Hudson, OH (US); John S. Dischinger, Danbury, CT (US); Chester Karwatowski, West Shokan, NY (US); Michael J. Martine, Chapel Hill, NC (US); Ajay Raina, Elmsford, NY (US)

(73) Assignee: INTERNATIONAL BUSINESS MACHINES CORPORATION, Armonk, NY (US)

(21) Appl. No.: 13/545,126

(22) Filed: Jul. 10, 2012

(51) Int. Cl. G06Q 30/00

(52) U.S. Cl. 705/26.7

(57) ABSTRACT

An automated technique for generating supplier recommendations may include: (1) receiving a set of supplier entity data indicating information about present transaction capabilities of a supplier entity; (2) storing the supplier entity data; (3) verifying the supplier entity data to generate a supplier entity data validation result; (4) updating the supplier entity data as verified supplier entity data based on the supplier entity data validation result; (5) receiving one or more items of supplier entity feedback data indicating information about previous transactions engaged in by the supplier entity with a buyer entity; (6) storing the supplier entity feedback data; (7) receiving a set of buyer entity criteria data indicating information about present transaction requirements of a buyer entity; and (8) generating a buyer entity recommendation based on consideration of the supplier entity data, the supplier entity data validation result, the supplier entity feedback information, and the buyer entity criteria data.

### BACKGROUND

1. Field

The present invention relates to automated tools for evaluating the fitness of potential trading partners for commercial transactions. More particularly, the invention is directed to automated techniques for generating supplier recommendation information that facilitates the selection of supplier entities by buyer entities.

2. Description of the Prior Art

By way of background, the use of communications networks to locate and interact with commercial trading partners has become pervasive. In the current state of the Internet, many suppliers of goods, services or other subject matters maintain websites that enable buyer entities to obtain information about supplier offerings, such as identifications of the products, services, or other subject matter, together with their price, availability, etc., and to execute online purchases or other trading transactions. There are also automated tools that allow buyer entities to search for and evaluate potential supplier entities so that an optimal supplier entity can be selected.

It is to improvements in the foregoing field that the present disclosure is directed. In particular, applicants disclose a technique that generates automated recommendations of supplier entities to buyer entities using a combination of buyer entity criteria, supplier entity input data, third party verified data and feedback from other buying entities.

### SUMMARY

A system, method and computer program product are provided to implement an automated technique for generating recommendations of potential supplier candidates to buyer entities. In an embodiment, the automated technique may include: (1) receiving via machine transmission from a first data processing host a set of supplier entity data indicating information about present transaction capabilities of a supplier entity; (2) storing the supplier entity data in a data storage device comprising a machine readable data storage medium; (3) verifying the supplier entity data using a machine-implemented data validation technique to generate a supplier entity data validation result; (4) updating the supplier entity data in the data storage resource as verified supplier entity data based on the supplier entity data validation result; (5) receiving via machine transmission from a second data processing host one or more items of supplier entity feedback data indicating information about previous transactions engaged in by the supplier entity with a buyer entity; (6) storing the supplier entity feedback data in a data storage device comprising a machine readable data storage medium; (7) receiving via machine transmission from a third data processing host a set of buyer entity criteria data indicating information about present transaction requirements of a buyer entity; and (8) generating a buyer entity recommendation based on consideration of the supplier entity data, the supplier entity data validation result, the supplier entity feedback information, and the buyer entity criteria data.

According to further example embodiments, the supplier entity data may comprise basic structured supplier information based on a predefined taxonomy, and supplemental unstructured supplier information. The verifying operation may comprise a machine-implemented data validation technique selected from the group consisting of (1) consulting an automated business intelligence reporting service, (2) consulting an automated governmental information service, (3) consulting one or more social media resources and performing automated business or social media analysis, and (4) using an automated business analysis tool. The supplier entity feedback data may be selected from the group consisting of (1) feedback information that is private to a single supplier, and (2) feedback information that is anonymously shared among plural suppliers. The buyer entity criteria data may comprise (1) generalized buyer business rules, (2) non-transaction-specific buyer preferences for suppliers and capabilities, and (3) transaction-specific buyer objectives. The buyer entity recommendation may be generated in response to a buyer entity request, or may be triggered by events or behaviors associated with a supplier entity. The buyer entity recommendation may be generated (1) using the buyer entity criteria and the supplier entity data to create a first list of potential supplier entities that assigns each of the potential supplier entities a first ranked score X, (2) using the supplier entity data validation result to create a refined second list of potential supplier entities that assigns each of the potential supplier entities with a second ranked score Y, and (3) using the supplier entity feedback data to create a refined third list of potential supplier entities that assigns each of the potential supplier entities with a third ranked score Z.

### BRIEF DESCRIPTION OF THE DRAWINGS

The foregoing and other features and advantages will be apparent from the following more particular description of example embodiments, as illustrated in the accompanying Drawings, in which:

FIG. 1 is a functional block diagram showing a computer system that may be used to implement the automated technique disclosed herein;

FIG. 2 is a functional block diagram showing example supplier web services of the system of FIG. 1;

FIG. 3 is a functional block diagram showing example buyer web services of the system of FIG. 1;

FIG. 4 is a flow diagram showing example supplier entity data entry operations that may be performed by the system of FIG. 1;

FIG. 5 a flow diagram showing example supplier entity data verification operations that may be performed by the system of FIG. 1;

FIG. 6 is a flow diagram showing example supplier entity selection and feedback operations that may be performed by the system of FIG. 1;

FIG. 7 a flow diagram showing example supplier entity recommendation operations that may be performed by the system of FIG. 1;

FIG. 8 is a functional block diagram showing an example machine apparatus that may be used to implement the system of FIG. 1; and

FIG. 9 is a diagrammatic perspective view showing example data storage media that may be used to store program instructions for implementing the operations of the system of FIG. 1.

### DETAILED DESCRIPTION OF EXAMPLE EMBODIMENTS

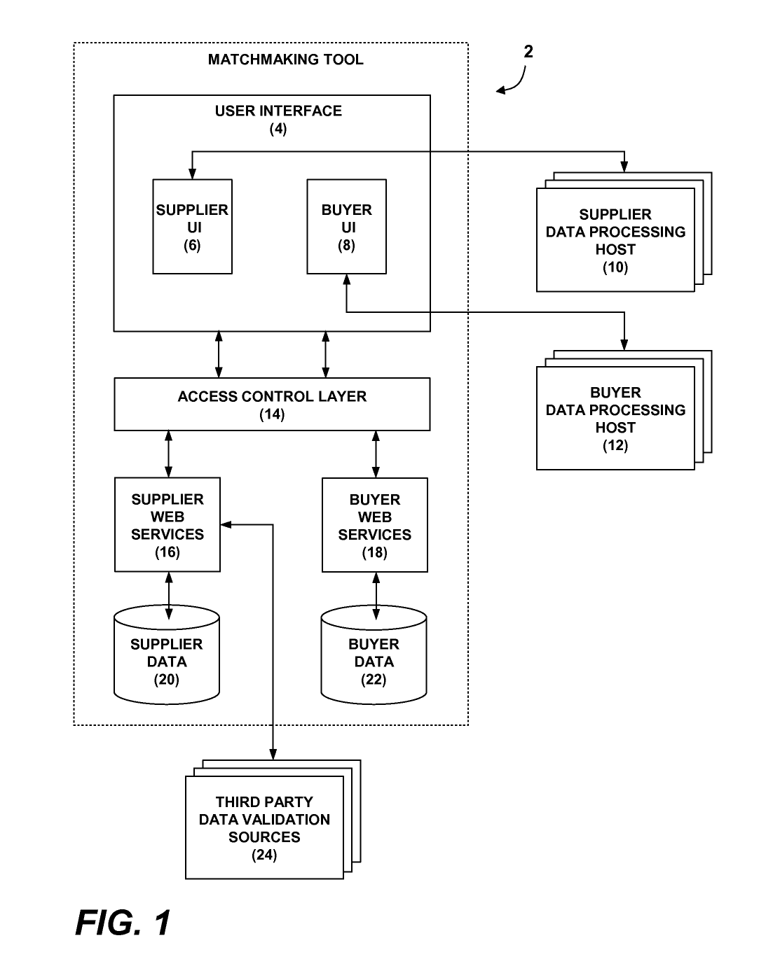

Turning now to the drawing figures, wherein like reference numbers indicate like elements in all of the several views, FIG. 1 illustrates an example computing system 2 that may be used to practice the subject matter disclosed herein. The computing system 2 is programmed to provide a commercial match-making tool that is especially suited to allow small supplier entities, such as small businesses, to present themselves to large buyer entities, such as public corporations, as candidates for commercial transactions. Notwithstanding the foregoing, the respective size of the buyer and supplier entities should not be considered a limiting factor with respect to usage of the system 2 insofar as buyer and supplier entities of any size may utilize the matchmaking tool that the system provides.

The system 2 includes a user interface suite 4 that includes a supplier entity interface 6 and a buyer entity interface 8. The supplier interface 6 supports interaction between the system 2 and one or more supplier entity data processing hosts 10 associated with one or more supplier entities (not shown). Similarly, the buyer interface 8 supports interaction between the system 2 and one or more buyer entity data processing hosts 12 associated with one or more buyer entities (not shown). The interfaces 6 and 8 may be implemented using any suitable computer interface technology, such as Internet web pages, that users interact with via a standard web browser using a suitable machine transmission technique (e.g. a communications network) to select underlying web service functionality and to input relevant web service data.

Underlying the user interface suite 4 is a conventional access control layer 14. The access control layer 14 performs the usual functions of enforcing web service security rules and access rights. It allows the data processing hosts 10 and 12 that respectively interact with the supplier entity interface 6 and the buyer entity interface 8 to respectively access underlying supplier web services 16 and buyer web services 18.

The supplier web services 16 utilize a supplier data store 20, such as a database, to store supplier entity data and verification results generated as a result of supplier interactions with the system 2. The buyer web services 18 likewise utilize a buyer entity data store 22, such as a database, to store supplier entity feedback information generated as a result of buyer entity interactions with the system 2. The supplier entity data store 20 and the buyer entity data store 22 can maintain their respective data in digital machine readable form on one or more data storage devices comprising one or more machine readable data storage media. It should be noted that the use of separate reference numbers for the supplier entity data store 20 and the buyer entity data store 22 does not necessarily mean that these resources are independent of each other. This may be the case in some embodiments. However, in other embodiments the supplier entity data store 20 and the buyer entity data store 22 could be implemented as a single data store (e.g., a singe database).

It should be noted that the foregoing components of the system 2 may be incorporated in a single machine apparatus, or may be a distributed system distributed among several machine apparatus that are interconnected via suitable communications pathways. As also shown FIG. 1, the system 2 may communicate with one or more third party data validation sources 24. Examples of such validation sources are described in more detail below.

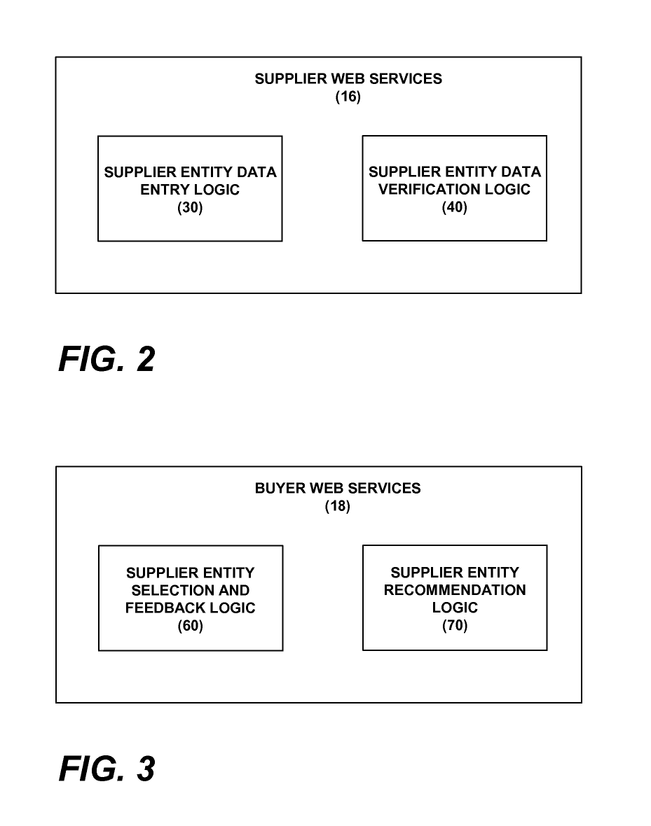

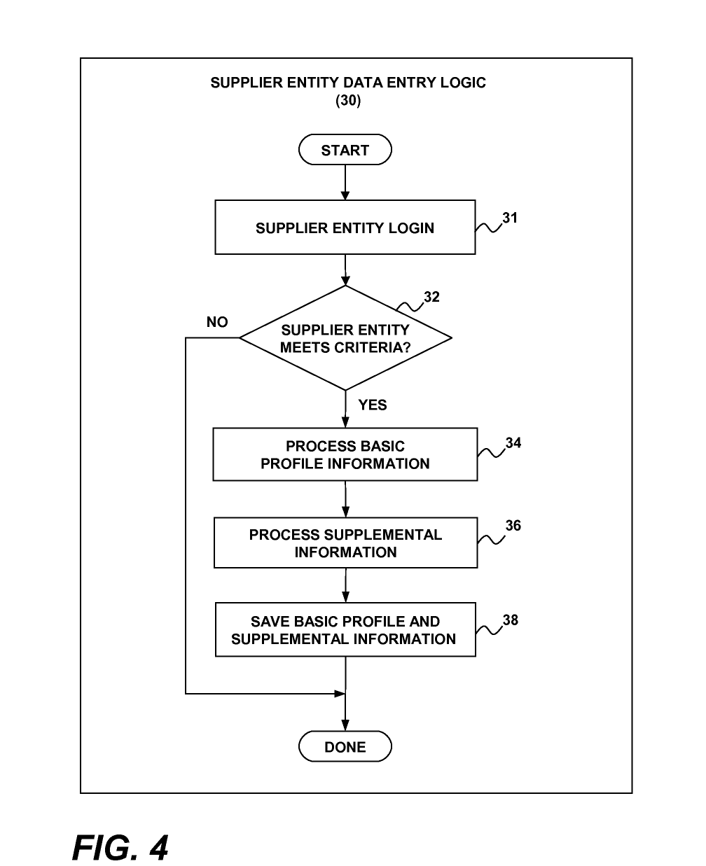

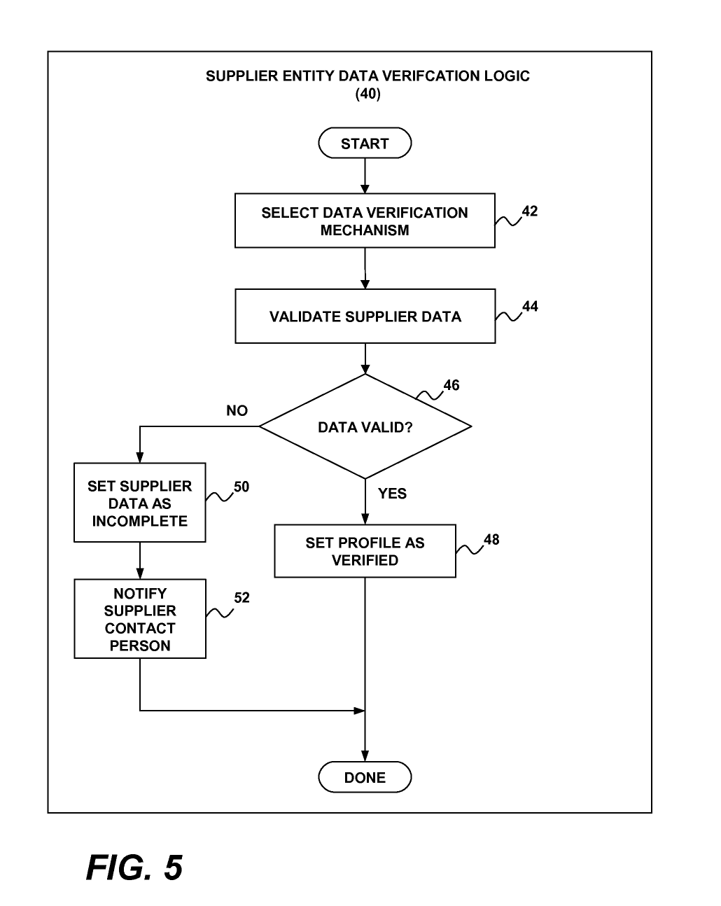

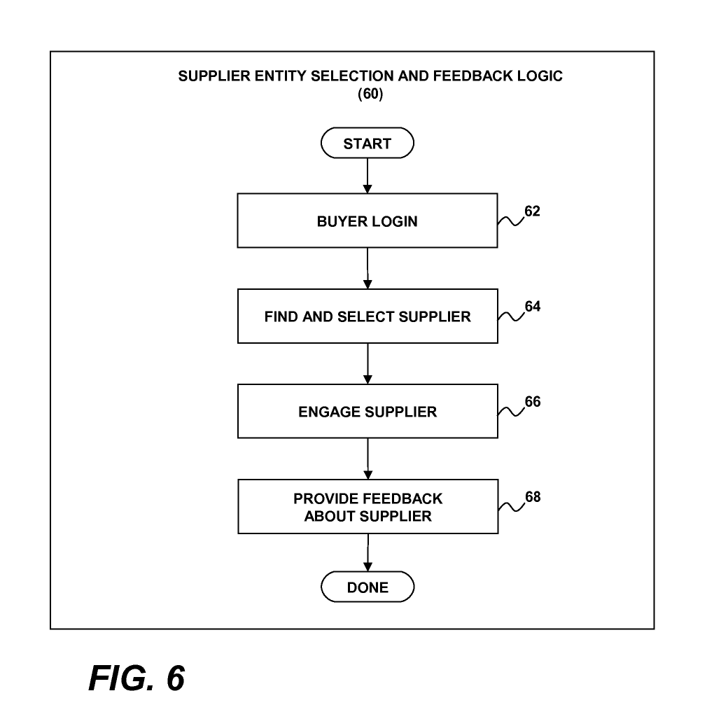

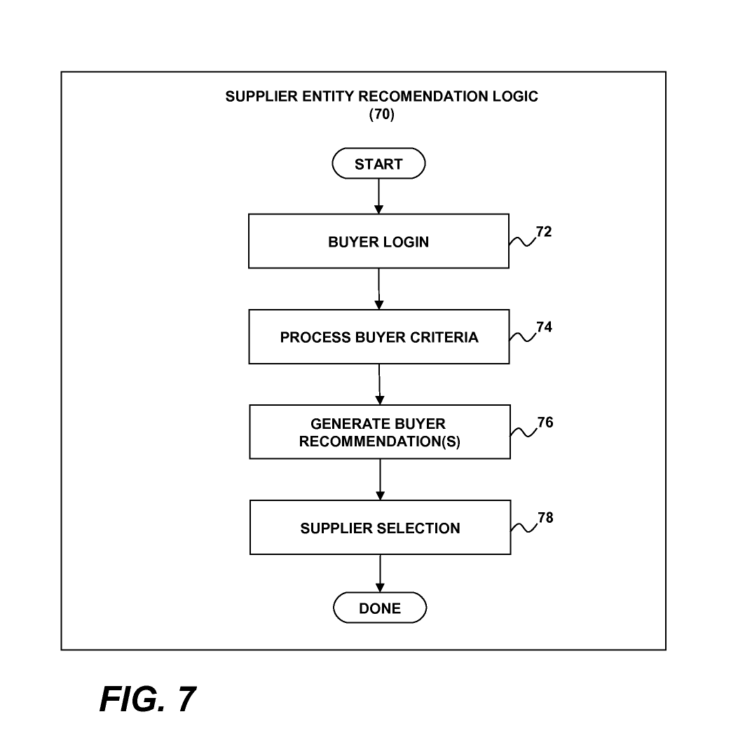

As shown in FIG. 2, the supplier web services 16 implement supplier entity data entry logic 30, which may include the data processing operations 32-38 shown in FIG. 4 (discussed below). The supplier web services 16 also implement supplier data verification logic 40, which may include the data processing operations 42-54 shown in FIG. 5 (discussed below). As shown in FIG. 3, the buyer web services 18 implement supplier entity selection and feedback logic 60, which may include the data processing operations 62-68 shown in FIG. 6 (discussed below). The buyer web services 18 also implement supplier entity recommendation logic 70, which may include the data processing operations 72-78 shown in FIG. 7 (discussed below).

Turning now to FIG. 4, the supplier entity data entry logic 30 allows suppliers to enter relevant information about themselves and their capabilities into the system 2. The operations of FIG. 4 may be implemented by the supplier data entry logic 30 using any suitable form of user interface processing, such as an interactive web page or a series of such web pages presented via the supplier entity user interface 6 of the system 2 (see FIG. 1). Block 31 is a supplier login operation wherein the supplier entity data entry logic 30 responds to a login request from one of the supplier entity data processing hosts 10 (see FIG. 1) by initiating a supplier entity interaction session between that host and the system 2. As part of the login operation, the supplier data entity logic 30 receives basic supplier entity identification and eligibility information, such as the supplier entity's name and contact information. Additional information may also be received, such as a federal tax ID, goods and services provided, total number of employees, total revenues, etc. In block 32, a check of the login information is performed to determine if the supplier meets basic supplier qualification criteria, and if not, the session is ended, possibly with an explanatory message being sent to the supplier entity via the supplier entity data processing host 10. One example of the supplier qualification criteria that may be checked in block 32 is whether the supplier provides goods or services that buyer entities have previously requested, such that there is a known market for such goods or services. Note that the supplier qualification operation of block 32 presupposes that the supplier data entry logic 30 will request and receive such information as part of as part of the login operation of block 31. If that is not the case, the supplier qualification check of block 32 could be performed following block 34 or 36, which will now be described.

In block 34, the supplier entity data entry logic 30 requests and receives basic supplier entity profile information from the supplier entity data processing host 10 in order to create one or more permanent supplier entity records for storage in the supplier data store 20. This operation may be likened to filling out the “Common Application” for undergraduate college admission, with the basic supplier entity profile information comprising structured supplier entity information based on a predefined taxonomy. In general, it is envisioned that the categories of the predefined taxonomy could be based on a cross-industry, cross-company agreement on a comprehensive supplier application process that broadens the opportunity for supplier entities to gain the attention of buyer entities. The use of a predefined taxonomy should simplify and standardize the supplier application process, not only for individual supplier entities, but across companies and across industries, and will also facilitate standardized data feeds into a variety of automated transactional tools and processes.

The basic information processed in block 34 may include any standardized business and technical information about the supplier entity that will help buyer entities assess supplier entity capabilities. By way of example only, the following information categories may be processed by the supplier entity data entry logic 30 as part of the operations of block 34:

1. Basic identification Information
a) Supplier Identification
b) Company Contacts
c) Related Company Information

2. Basic Capability Information
a) Supplier Entity Size and Structure
b) Goods and/or Services

3. Financial Information

4. e-Enablement Capabilities

5. Quality Certifications and Environmental Management Systems

6. Export Control/Social Responsibility Compliance and Conflict Disclosure

7. Data Security

8. Independent Contractor Disclosure

9. Diversity

In block 36, the supplier entity data entry logic 30 may request and receive supplemental supplier entity information to be stored as one or more permanent supplier entity records in the supplier data store 20. The supplemental information received in block 36 represents unstructured supplier entity information that is not based on a predefined taxonomy. This information is optional and allows a supplier entity to provide relevant information that is outside the scope of the basic profile information of block 36. Examples of such information include, but are not limited to, copies of supplier entity informational documents (such as brochures), links to supplier entity webpages and business or social media sites, etc. Using these and other data sources, supplier entities may self-report a variety of attributes, references, capabilities and data that may be increase the confidence levels of supplier entity recommendations made by the supplier entity recommendation logic 70 (discussed below), thereby resulting in improved decision making for buyer entities.

In block 38, the information received in blocks 34 and 36 is permanently stored in the supplier data store 20, such as by creating one or more supplier entity records. The data storage operation of block 38 may be triggered by a predetermined event, such as an information submission request sent by the supplier entity data processing host 10 when a supplier entity has finished specifying the information of blocks 34 and 36. Other triggers may also be used. Once the supplier entity information is stored, it can be made available for subsequent editing and/or supplementation by the supplier entity, as well as for viewing by buyer entities, other supplier entities, or any other interested party.

Turning now to FIG. 5, the supplier entity data verification logic 40 allows the supplier entity data processed by the supplier entity data entry logic 30 to be validated to produce a data validation result. Because a supplier entity's data may change periodically, supplier entity data verifications may be performed periodically, such as upon request by a buyer entity. A successful validation will result in the supplier entity data being designated as verified supplier entity data. An unsuccessful validation result may result in the supplier entity data being designated as incomplete. The overall goal of the supplier entity data verification process is to improve supplier entity data quality and the supplier entity recommendations made by the supplier entity recommendation logic 70. Also, regular data verification may indicate whether the supplier entity data is current, thereby encouraging the supplier entities to regularly update their information. Currency of data will affect confidence ratings associated with the supplier entity recommendations.

In block 42, the supplier entity data verification logic 40 selects one or more data verification mechanisms for validating the supplier entity data stored in the supplier data store 20 for a selected supplier entity. As part of this processing, the supplier entity data verification logic 40 may inspect both the basic profile information and the supplemental information of the supplier entity. Because the supplemental information varies by supplier entity, different data verification mechanisms may be required for different supplier entities. Alternatively, the supplier entity data verification logic 40 might only consider the basic profile information, and the same data verification mechanism(s) could be used for all supplier entities. There are any number of conventionally available data verification mechanisms, including but not limited to the following:

1. Business Intelligence Reporting Services
a) Dunn and Bradstreet Financial Report
b) Gartner or Bloomberg Emerging Business Intelligence Report

2. Governmental Information Service
a) Federal/State/Local Government Agencies
b) US Government Denied Parties Listing

3. Business/Social Media Resources And Analysis
a) Facebook
b) Linkedin

4. Automated Business Tools
a) IBM Total Risk
b) IBM Supplier Financial Risk Assessment Tool

In block 44, the supplier entity data verification logic 40 initiates validation of the supplier entity data using the selected data verification mechanism(s). As described above, there are a number of data validation mechanisms that may be invoked. Some will require the supplier entity data verification logic 40 to consult remote data processing systems that host reporting, information or business/social media services. These remote systems are represented by the third party validation sources 24 of FIG. 1. Other data verification mechanisms will require the supplier entity to invoke software tools that may run locally on the system 2 or remotely on another system.

In block 46, the supplier entity data verification logic 40 determines whether the supplier entity data is valid. If it is, the supplier entity data may designated in block 48 as verified supplier entity data in the supplier data store 20. If the supplier entity data cannot be validated, or if it is determined to be invalid, block 50 may be implemented and the data may be designated as incomplete in the supplier data store 20. In block 52, the supplier entity data verification logic 40 may notify a contact person associated with the supplier entity, such as by sending an email or SMS text message, to notify the buyer entity of a data verification problem. Note that the supplier entity data verification logic 40 may assign a confidence level to a supplier entity data validation result. For example, some components of the supplier entity data may be relatively easy to verify (e.g., historical financial data) whereas other components may not (e.g., claims of supplier expertise). This may be result in the assignment of a confidence level that lies within a predefined range of confidence levels.

Turning now to FIG. 6, the supplier entity selection and feedback logic 60 allows a buyer entity to select a supplier entity, engage the supplier entity in a commercial transaction, and then provide supplier entity feedback data indicating information about the supplier entity, its ability to handle the transaction, or any pertinent assessment information that may be of benefit to other buyer entities regarding this particular supplier entity. The operations of FIG. 6 may be implemented by the supplier entity selection and feedback logic 60 using any suitable form of user interface processing, such as an interactive web page or a series of such web pages presented via the buyer user interface 8 of the system 2 (see FIG. 1).

In block 62, the supplier entity selection and feedback logic 60 responds to a login request from one of the buyer entity data processing hosts 12 (see FIG. 1) by initiating a buyer entity interaction session between that host and the system 2. In block 64, the supplier entity selection and feedback logic 60 performs processing that allows the buyer entity to find and select a supplier entity for engagement as commercial transaction partner. As part of this processing, the supplier entity selection and feedback logic 60 may provide a basic search capability that allows the buyer entity to submit queries to the supplier data store 20 to identify suitable supplier entity candidates. Such queries may encompass data comprising both the structured basic supplier basic profile information discussed above in connection with block 34 of FIG. 4, and the unstructured supplemental information discussed in connection with block 36 of FIG. 4. Alternatively, the selection of a supplier entity in block 64 could be based on a supplier recommendation made by the supplier entity recommendation logic 70. The details of such logic are described in more detail below.

In block 66, a buyer entity invokes the supplier entity selection and feedback logic 60 to engage the selected supplier entity in a commercial transaction. For this purpose, the supplier entity selection and feedback logic 60 may implement or invoke any of various automated trading tools that support automated trading between commercial entities over a network. Alternatively, the buyer entity could engage the supplier entity independently of the system 2.

In block 68, the supplier entity and feedback logic 60 receives and processes supplier entity feedback data provided by the buyer entity. This data indicates information about the supplier entity based on one or more previous transactions between the supplier entity and the buyer entity. If desired, the buyer entity may be allowed to specify whether the feedback information is reserved for the buyer entity's private use only, or may be shared anonymously with other buyer entities to improve the accuracy of the supplier entity recommendations made by the supplier entity recommendation logic 70. The buyer's choice whether the supplier entity feedback information is private or public may dictate where the feedback information is stored. If the supplier entity feedback information is private, it may be more efficient to store it in one or more records of the buyer entity data store 22 (see FIG. 1) in association with the buyer entity that generated the information. If the supplier entity feedback information is public, it may be more efficient to store it in one or more records of the supplier entity data store 20 (see FIG. 1).

The supplier entity feedback information may include various kinds of feedback. For example, it may include supplier entity rating information based on a standardized rating system. Various categories of supplier entity performance may be rated, including but not limited to quotation/price discrepencies, quality problems, delivery delays, etc. The supplier entity rating information may also include non-categorized information relating to the buyer entity's experience with the supplier entity with respect to various aspects of the supplier entity's performance in connection with one or more transactions. To provide context, details of such transactions may be included in the supplier entity feedback information. An overall assessment of supplier entity capabilities may also be provided.

In order to render the supplier entity feedback information more meaningful, the information may further include buyer entity criteria that indicates what may have motivated the buyer entity to engage the supplier entity, and to what extent that the buyer entity's objectives were met. The topic of buyer entity criteria is discussed in more detail below connection with the supplier entity recommendation logic 70. Examples of such criteria include, but are not limited to, buyer entity preferences for supplier entities and capabilities, buyer entity practices and policy requirements, buyer objectives for particular transactions, etc.

Turning now to FIG. 7, the supplier entity recommendation logic 70 allows a buyer entity to specify various buyer entity criteria that will be processed in conjunction with pre-existing supplier entity data, supplier entity validation results, and supplier entity feedback information. The result is a buyer entity recommendation that identifies one or more candidate supplier entities with whom the buyer entity may wish to consider for a commercial transaction. The operations of FIG. 7 may be implemented by the supplier entity recommendation logic 70 using any suitable form of user interface processing, such as an interactive web page or a series of such web pages presented via the buyer user interface 8 of the system 2 (see FIG. 1).

In block 72, the supplier entity recommendation logic 70 responds to a login request from one of the buyer entity data processing hosts 12 (see FIG. 1) by initiating a buyer entity interaction session between that host and the system 2. In block 74, the supplier entity recommendation logic 70 receives processes a set of buyer entity criteria data indicating information about present transaction requirements of the buyer entity. As part of this processing, the supplier entity recommendation logic 70 stores the buyer criteria data in one or more records of the buyer entity data store 22 (see FIG. 1).

The buyer entity criteria data may comprise various types of information representing different levels of generality. For example, the buyer entity criteria data might include such categories as (1) generalized buyer entity business rules, (2) non-transaction-specific buyer entity preferences for suppliers and capabilities, and (3) transaction-specific buyer entity objectives. An example of category (1) would be general business and sourcing policies and objectives, such as a buyer entity business rule specifying that a supplier entity must be of sufficient size so that business dealings with the buyer entity will not represent more than 20% of the supplier entity's total capacity. An example of category (2) would be geographic and business preferences, such as a non-transaction-specific buyer entity preference for supplier entities located within a certain distance from the buyer entity. An example of category (3) would be a specification of specific categories of goods and services, such as a transaction-specific buyer entity objective that a supplier entity is needed for snow removal. Category (3) could also specify transaction-specific conditions, such as a condition specifying that a supplier entity is needed on a one-time only emergency basis (e.g., for snow removal following a blizzard) instead of for a long-term contract. Note that category (3) need not necessarily include basic contract-related attributes such as price, quantity, quality, availability. Although such attributes could be specified if so desired, they would typically be dealt in a subsequent stage in which a buyer entity initiates an RFP/RFQ (Request For Price/Request For Bid) from a selected supplier entity, or when the buyer entity consummates an actual commercial transaction.

In some cases, the buyer entity criteria data may include information corresponding to the structured basic profile information associated with the supplier entities. However, because the taxonomy of such data may not have the granularity required for identifying the most suitable supplier entities, the buyer entity criteria data may also include information corresponding to the unstructured supplemental information associated with supplier entities. Such information will not comply with a strict taxonomy. The buyer entity criteria data may thus represent both structured and unstructured data queries. For example, the buyer entity criteria data might comprise a request for a supplier entity that performs snow removal and has sufficient capacity to handle a specified job size within a specified time frame.

In block 76, the supplier entity recommendation logic 70 generates buyer entity recommendations. This operation may be triggered in response to a buyer entity request, (e.g., following a buyer entity specifying its buyer entity criteria) or may be triggered by events or behaviors that are specified as part of the buyer entity criteria. An example of an event that might trigger a buyer entity recommendation would be a specific event-oriented change in status of a supplier entity, such as a merger or acquisition, a bankruptcy, etc. An example of a behavior that might trigger a buyer entity recommendation would be non-specific change in the behavior of a supplier entity, such as the supplier entity experiencing a spike in its growth rate and being perceived as a trending new company.

The recommendation processing of block 76 produces a buyer entity recommendation based on consideration of supplier entity data, supplier entity data validation results, supplier entity feedback information, and the buyer entity criteria data. The supplier entity recommendation logic 70 may utilize a variety of existing recommendation engines to perform the recommendation processing of block 76. For example, a deterministic recommendation engine could be used for evaluating the basic structured supplier information, and a non-deterministic recommendation engine (e.g., a business/social media sentiment analysis tool) could be used for evaluating the supplemental unstructured supplier information. In either case, different weights may be applied to different types of buyer entity criteria data. The goal of using such tools is to provide a recommendation that potentially represents the result of deep analytics of business characteristics measured against a potentially complex set of expectations and needs, and with the ability to learn from previous decisions and recommendations. Recommendation tools that consider non-supplier-entity-specific data, such as such as news feeds or other current events information, could also be used. For example, consider a buyer entity searching for a supplier entity that provides overseas shipping. One supplier entity is an air freight service and the other is an ocean freight service. In some situations the resultant recommendation might be the supplier entity that provides air freight service due to reduced delivery time and low cost. However, there could be extraneous considerations (e.g., a news report of a volcano eruption that results in airport closures) that cause the supplier entity recommendation logic 70 to recommend the supplier entity that provides ocean freight service. Persons skilled in the art will appreciate that the benefits of the present disclosure do not depend on which particular recommendation tools are selected. Rather, the selection of such tools is considered to be a matter of design choice that will depend on particular analytic goals and needs.

In an embodiment, the recommendation processing of block 76 may be formed in stages, with each stage producing a ranking listing of potential supplier candidates that is successively refined to produce a final list. In a first recommendation processing stage, the supplier entity recommendation logic 70 maps the buyer entity criteria data stored in the buyer entity data store 22 against the supplier entity data stored in the supplier entity data store 20. This processing may result in the generation of a first list of potential supplier entities that assigns each potential supplier a first ranked score X.

In a second recommendation processing stage, the supplier entity recommendation logic 70 applies the supplier entity validation result stored in one or both of the supplier entity data store 20 or the buyer entity data store 22 to create a refined second list of potential supplier entities that assigns each potential supplier entity a second ranked score Y that may be different than the first ranked score X. For example, the ranking of a supplier entity may drop if its supplier entity data cannot be verified, or if can only be verified with a low level of confidence. This processing may implement stochastic processing that is based on a likelihood that a supplier entity can satisfy the supplier entity criteria data. The weight given to the supplier entity validation result may also vary based on specific elements of the buyer entity criteria data. Thus, a match on a service that is critical to a buyer entity but is not validated may weigh higher than a non-critical service that is validated with a high confidence level. For example, an unverified supplier entity that is within five miles of a buyer entity may rank as high as a verified supplier entity that is fifty miles away. Likewise, a buyer entity that requires a supplier entity to provide one-time emergency service may not be concerned whether the supplier entity data is verified if other supplier entities have questionable availability. On the other hand, data verification may be essential if a long-term contract is being considered.

In a third recommendation processing stage, the supplier entity recommendation logic 70 uses the supplier entity feedback data to create a third refined list of potential supplier candidates that assigns each potential supplier entity a second ranked score Z that may be different than the second ranked score Y. For example, a high scoring supplier entity in the second list may not fare well in the third list if there is significant negative feedback. Again, the weight to be given such feedback may depend on the buyer entity's criteria and needs, such that a supplier entity with negative feedback may rank high under certain circumstances.

Block 76 of the supplier entity recommendation logic 70 is completed by presenting the third list of potential supplier entities to an inquiring buyer entity. In block 78, the buyer entity invokes the supplier entity recommendation logic 70 to make a supplier entity selection. When this occurs, the supplier entity recommendation logic 70 may update the supplier entity data associated with the selected buyer entity, such as by increasing a count of the number of times the buyer entity has been selected. At this point in the processing, block 66 of the supplier entity selection and feedback logic 60 (see FIG. 6) may be invoked if the buyer entity wishes to engage the selected supplier entity in a commercial transaction. As previously described, the supplier entity selection and feedback logic 60 may implement or invoke any of various automated trading tools that support automated trading between commercial entities over a network. Alternatively, the buyer entity could engage the supplier entity independently of the system 2.

If desired, the supplier entity recommendation logic 70 could be augmented to provide complimentary recommendations for supplier entities that provide goods or services that compliment the goods or services offered by an initially selected supplier entity. As one example, if a buyer entity is looking for an architect to design a building, the supplier entity recommendation logic 70 could additionally recommend a general contractor, and possibly one or more subcontractors, to handle the construction.

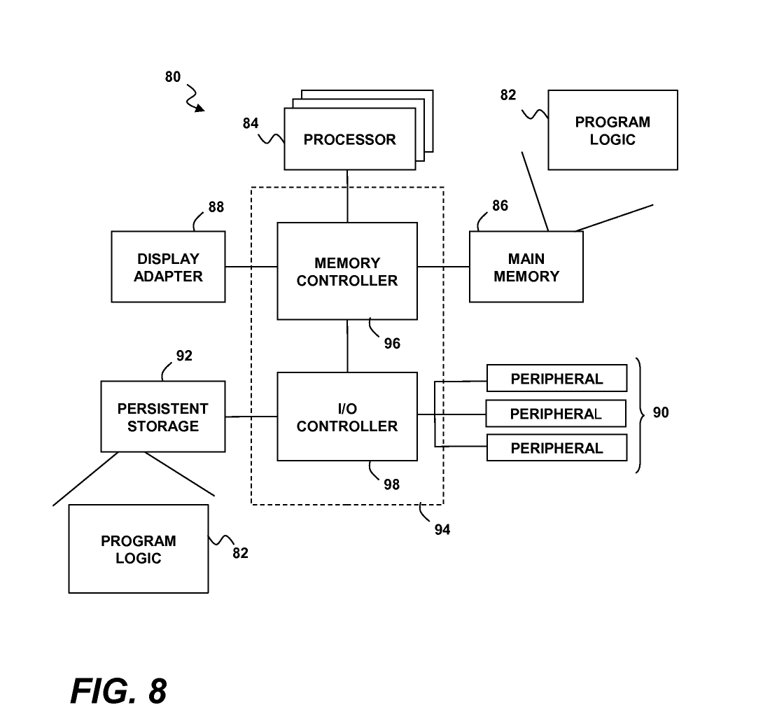

Turning now to FIG. 8, an example machine apparatus 80 is shown that may be used to implement the hardware and software resources of the system 2. Alternatively, if the system 2 is distributed, plural instances of the apparatus 80 could be used to implement particular portions of the system 2. The apparatus 80 executes program logic 82 that comprises the various functions of the logic entities 30, 40, 60 and 70 described above. According to one possible embodiment, the apparatus 80 may include one or more processors 84 that operate in conjunction with a main memory 86. The processors 84 may comprise general purpose processors or they may be custom-designed to support special purpose operations. Each processor may be implemented as an integrated circuit device (also known as a processor chip) that comprises one or more CPU cores. The memory 86 may be implemented using any type of computer readable storage media capable of storing program instructions and data utilized by the processors 64 during instruction processing operations. Such media are typically referred to as primary storage. Examples include, but are not limited to, static or dynamic random-access memory, semiconductor read-only memory, or combinations thereof. The processors 84 and the memory 86 may be situated within a single computing node (e.g., as part of a single-node SMP system) or they may be distributed over plural nodes (e.g., as in a distributed NUMA system, a cluster, a cloud, etc.). Although not shown, conventional cache memories may be respectively associated with the processors 84 to buffer the program logic 82 stored in the main memory 86.

Additional components of the apparatus 80 may include a display adapter 88 (e.g., a graphics card) for generating visual output information (e.g., text and/or graphics) to a display device (not shown), and various peripheral devices 90 that may include a keyboard or keypad input device, a pointer input device, a network interface card (NIC), a USB bus controller, a SCSI disk controller, etc. A persistent storage device 92 may also be provided. The persistent storage device 92 may be implemented using many different types of data storage hardware, including but not limited to magnetic or optical disk storage, solid state drive storage, flash drive storage, tape backup storage, or combinations thereof. A bus or other communications infrastructure 94, which may include a memory controller hub or chip 96 (e.g., a northbridge) and an I/O (input/output) controller hub or chip 98 (e.g., a southbridge), may be used to interconnect the foregoing elements. It should be understood that the foregoing description is for purposes of illustration only, and that other components and arrangements may also be used to configure the apparatus 80 depending on the system architecture thereof.

The program logic 82 may be implemented in software, firmware or a combination thereof, and with some (or all) operations potentially being performed by dedicated hardware logic. If implemented in software, the program logic 82 may be loaded from the persistent storage 92 into a portion of the main memory 86 that comprises RAM. If implemented in firmware, the program logic 82 could reside in a portion of the main memory 86 that comprises ROM, such as EPROM memory. The program logic 82 may comprise a collection of program instructions, possibly having entry and exit points, written in a suitable programming language. Such programming languages may include, but are not limited to, a high level procedural language such as C, a high level object oriented language such as C++, an interpreted language such as Java, BASIC, Perl, Python, or a lower level language such as assembly. The program instructions written in such languages may be compiled and/or interpreted and/or assembled (as the case may be) into machine language program instructions that are capable of execution on the processor(s) 84. When the machine language program instructions are loaded into and executed by the processor(s) 84, the resultant programmed apparatus 80 becomes a particular machine for practicing the subject matter described herein. The program instructions of the program logic 82 may be embodied in one or more modules, each of which may be compiled and linked into an executable program, installed in a dynamically linked library, or otherwise made ready for invocation and execution by the apparatus 80. The module(s) may be implemented to run with or without the support of an underlying operating system. They may be callable from other modules or from themselves, and/or may be invoked in response to detected events or interrupts.

As previously mentioned, some aspects of the program logic 82 could be implemented using dedicated logic hardware. Examples of such hardware would include connected logic units such as gates and flip-flops, and/or integrated devices, such as application specific integrated circuits (ASICs), field programmable gate arrays (FPGAs)), reconfigurable data path arrays (rDPAs) or other computing devices. The design, construction and operation of such devices is well known in the art, and will not be described further herein in the interest of brevity.

Accordingly, a technique has been disclosed for generating recommendations of potential supplier entity candidates to buyer entities. It will be appreciated that the foregoing concepts may be variously embodied in any of a machine implemented method, a computing system, and a computer program product. Example embodiments of a machine-implemented method have been described in connection with FIG. 4-7. Example embodiments of a computing system has been described in connection with FIGS. 1-3 and 8. With respect to a computer program product, digitally encoded program instructions may be stored on one or more data storage media for use in controlling a CPU or other instruction processing device to perform operations. The program instructions may be embodied as machine language code that is ready for loading and execution by the machine apparatus, or the program instructions may comprise a higher level language that can be compiled and/or interpreted and/or assembled into machine language. Example languages include, but are not limited to C, C++, Java, assembly, to name but a few. When implemented on a machine apparatus comprising a processor, the program instructions combine with the processor to provide a particular machine that operates analogously to specific logic circuits, which themselves could be used to implement the disclosed subject matter.

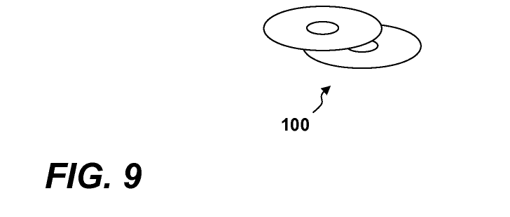

Example computer-readable storage media for storing digitally encoded program instructions are shown by reference numerals 86 (memory) and 92 (persistent storage) of the machine apparatus 80 in FIG. 8. A further example of computer-readable storage media that may be used to store the program instructions is shown by reference numeral 100 in FIG. 9. The storage media 100 are illustrated as being portable optical storage disks of the type that are conventionally used for commercial software sales, such as compact disk-read only memory (CD-ROM) disks, compact disk-read/write (CD-R/W) disks, and digital versatile disks (DVDs). Such storage media can store the program instructions either alone or in conjunction with an operating system or other software product that incorporates the required functionality. The storage media could also be provided by portable magnetic or electrical storage media (such as floppy disks, USB flash devices, etc.). The storage media may also be combined with drive systems (e.g. disk drives), or incorporated in a computing system (e.g., as random access memory (RAM), read-only memory (ROM) or other semiconductor or solid state memory). More broadly, the storage media could comprise any electronic, magnetic, optical, magneto-optical, infrared, semiconductor system or apparatus or device, or any other tangible entity representing a machine, manufacture or composition of matter that can contain, store, communicate, or transport the program instructions for use by or in connection with an instruction execution system, apparatus or device, such as a computer. For all of the above forms of storage media, when the program instructions are loaded into and executed by a computing system, the resultant programmed system becomes a particular machine for practicing embodiments of the method(s) and system(s) described herein.

Although various embodiments of the invention have been described, it should be apparent that many variations and alternative embodiments could be implemented in accordance with the present disclosure. It is understood, therefore, that the invention is not to be in any way limited except in accordance with the spirit of the appended claims and their equivalents.

8. A system, comprising:
one or more processors;
a memory operably coupled to said one or more processors;
program instructions stored in said memory for programming said one or more processors to perform operations for generating recommendations of potential supplier candidates, said operations comprising:
receiving via machine transmission from a first data processing host a set of supplier entity data indicating information about present transaction capabilities of a supplier entity;
storing said supplier entity data in a data storage device comprising a machine readable data storage medium;
verifying said supplier entity data using a machine-implemented data validation technique to generate a supplier entity data validation result;
updating said supplier entity data in said data storage resource as verified supplier entity data based on said supplier entity data validation result;
receiving via machine transmission from a second data processing host one or more items of supplier entity feedback data indicating information about previous transactions engaged in by said supplier entity with a buyer entity;
storing said supplier entity feedback data in a data storage device comprising a machine readable data storage medium;
receiving via machine transmission from a third data processing host a set of buyer entity criteria data indicating information about present transaction requirements of a buyer entity; and
generating a buyer entity recommendation based on consideration of said supplier entity data, said supplier entity data validation result, said supplier entity feedback information, and said buyer entity criteria data.

9. The system of claim 8, wherein said supplier entity data comprises basic structured supplier information based on a predefined taxonomy and supplemental unstructured supplier information.

10. The system of claim 8, wherein said verifying operation comprises a machine-implemented data validation technique selected from the group consisting of (1) consulting an automated business intelligence reporting service, (2) consulting an automated governmental information service, (3) consulting one or more business or social media resources and performing automated business or social media sentiment analysis, and (4) using an automated business analysis tool.

11. The system of claim 8, wherein said supplier entity feedback data is selected from the group consisting of (1) feedback information that is private to a single supplier, and (2) feedback information that is anonymously shared among plural suppliers.

12. The system of claim 8, wherein said buyer entity criteria data comprises (1) generalized buyer business rules, (2) non-transaction-specific buyer preferences for suppliers and capabilities, and (3) transaction-specific buyer objectives, said transaction-specific objectives including whether a buyer entity is seeking a one-time transaction or a long-term contract.

13. The system of claim 8, wherein said generating a buyer entity recommendation is performed in response to a buyer entity request or is triggered by events or behaviors associated with a supplier entity, said buyer entity request including one or both of a structured query request based on a predetermined taxonomy or an unstructured query request that is not based on a predetermined taxonomy.

14. The system of claim 8, wherein said generating a buyer entity recommendation comprises (1) using said buyer entity criteria and said supplier entity data to create a list of potential supplier entities that assigns each of said potential supplier entities a first ranked score X, (2) using said supplier entity data validation result to create a refined second list of potential supplier entities that assigns each of said potential supplier entities a second ranked score Y, and (3) using said supplier entity feedback data to create a refined third list of potential supplier entities that assigns each of said potential supplier entities a third ranked score Z.

15. A computer program product, comprising:
one or more data storage media;
a computer program stored on said one or more data storage media, said computer program comprising instructions for generating recommendations of potential supplier candidates, said operations comprising:
receiving via machine transmission from a first data processing host a set of supplier entity data indicating information about present transaction capabilities of a supplier entity;
storing said supplier entity data in a first digital data store maintained by a data storage device comprising a machine readable data storage medium;
verifying said supplier entity data using an machine-implemented data validation technique;
updating said supplier entity data in said data storage resource as verified supplier entity data based on a result of said verifying operation;
receiving via machine transmission from a second data processing host one or more items of supplier entity feedback data indicating information about previous transactions engaged in by said supplier entity with a buyer entity;
storing said supplier entity feedback data in said digital data storage resource;
receiving via machine transmission from a third data processing host a set of buyer entity criteria data indicating information about present transaction requirements of a buyer entity; and
generating a buyer entity recommendation based on consideration of said supplier entity data, said supplier entity data validation result, said supplier entity feedback information, and said buyer entity criteria data.

16. The computer program product of claim 15, wherein said supplier entity data comprises basic structured supplier information based on a predefined taxonomy and supplemental unstructured supplier information.

17. The computer program product of claim 15, wherein said verifying operation comprises a machine-implemented data validation technique selected from the group consisting of (1) consulting an automated business intelligence reporting service, (2) consulting an automated governmental information service, (3) consulting one or more business or social media resources and performing automated business or social media sentiment analysis, and (4) using an automated business analysis tool.

18. The computer program product of claim 15, wherein said supplier entity feedback data is selected from the group consisting of (1) feedback information that is private to a single supplier, and (2) feedback information that is anonymously shared among plural suppliers.

19. The computer program product of claim 15, wherein said buyer entity criteria data comprises (1) generalized buyer business rules, (2) non-transaction-specific buyer preferences for suppliers and capabilities, and (3) transaction-specific buyer objectives, said transaction-specific objectives including whether a buyer entity is seeking a one-time transaction or a long-term contract.

20. The computer program product of claim 15, wherein said generating a buyer entity recommendation is performed in response to a buyer entity request or is triggered by events or behaviors associated with a supplier entity, said buyer entity request including one or both of a structured query request based on a predetermined taxonomy or an unstructured query request that is not based on a predetermined taxonomy.

21. The computer program product of claim 15, wherein said generating a buyer entity recommendation comprises (1) using said buyer entity criteria and said supplier entity data to create a list of potential supplier entities that assigns each of said potential supplier entities a first ranked score X, (2) using said supplier entity data validation result to create a refined second list of potential supplier entities that assigns each of said potential supplier entities a second ranked score Y, and (3) using said supplier entity feedback data to create a refined third list of potential supplier entities that assigns each of said potential supplier entities a third ranked score Z.

22. (canceled)
